(19) United States
(12) Patent Application Publication
(10) Pub. No.: US 2021/0039042 A1
(43) Pub. Date: Feb. 11, 2021

(54) ATOMS POWER - FULLY INTEGRATED WATER, CLIMATE CONTROL AND ENERGY PRODUCTION SYSTEM

(71) Applicant: 7142871 Canada Inc., Montreal (CA)

(72) Inventors: Mario Caggiano, Montreal (CA); Michael Jennings, Folsom, LA (US)

(21) Appl. No.: 17/027,138

(22) Filed: Sep. 21, 2020

Related U.S. Application Data
(60) Provisional application No. 62/922,021, filed on Jul. 22, 2019.

(51) Int. Cl. B01D 53/26; F25B 40/04; E03B 3/28; F25D 21/14; B01D 53/06

(52) U.S. Cl. CPC B01D 53/261; F25B 40/04; E03B 3/28; B01D 2259/4009; B01D 53/06; B01D 2257/80; F25D 21/14

(57) ABSTRACT

A water production system is provided that uses ambient air, a desiccant, a refrigeration cycle, and heat generated by the refrigeration cycle to generate water that may be used when water is scarce, for example during a natural disaster recovery operation. The system may use commercial electrical power in one embodiment, but when commercial electrical power is unavailable, it may rely on generator power. When it relies on generator power, the system may use excess heat exhausted by the generator to heat ambient air prior to its introduction to the desiccant.

### CROSS-REFERENCES TO RELATED APPLICATIONS

This Application claims priority to U.S. Provisional Patent Application Ser. No. 62/922,021, filed on Jul. 22, 2019, currently pending, the entire disclosure of which is incorporated herein by reference

### FIELD OF THE INVENTION

The present invention relates generally to a water generation system, and more particularly, to an autonomous atmospheric water generator that can produce large quantities of potable water in various climatic conditions.

### BACKGROUND OF THE INVENTION

In remote areas, temporary construction sites, and areas impacted by natural disasters, it is a challenge to provide safe drinking water to residents, volunteers, and/or professional workers. Costs to provide bottled water in a disaster such as a hurricane or tornado, for example, can cost as much as $4 per liter. In times of crises, such costs are difficult to bear given the great deal of capital that will need to be provided to rebuild the community. That is not to mention the well-documented wasteful impact that plastic bottle waste has on the community.

An example of a water production system is provided in U.S. Pat. No. 8,551,230, which is incorporated herein by reference. That system, however, does not make use of excess energy created by the system when producing water. A solution is desired that provides safe, potable water to remote areas and construction areas. The solution should be inexpensive, easy to operate, and efficient.

### SUMMARY OF THE INVENTION

The system described herein uses thermodynamic principles to generate water. More particularly, the system uses ambient air, a desiccant, a refrigeration cycle, and heat generated by the refrigeration cycle to generate water.

In the system, water vapor is captured into the desiccant by passing ambient air through the dessicant. Moisture suspended in vapor form is thus sucked into the desiccant wheel as it passes therethrough. Via a separate air flow, air is heated before it is passed through the moisture-laden desiccant, causing the desiccant to release the captured moisture into the heated regeneration air flow. The hot, humid air produced from the regeneration of the desiccant creates an atmospheric condition that is basis for water production. The hot, humid air contacts an evaporator that, using known refrigerant principles, rapidly cools the hot, humid air and causes it to release its moisture. That collected moisture manifests as potable water, which is subsequently collected and filtered.

Not only does the system collect water, but it does so in a power-efficient way. In a first embodiment where the system is powered using commercial electrical power, a desuperheater is placed between the compressor and condenser used in the refrigeration cycle that cools the evaporator. That desuperheater collects excess heat generated when refrigerant travels from the compressor to the condenser. That excess heat is used to heat the air before it is passed through the desiccant to collect moisture captured therein. In addition to the heat from the superheater, an electric heater may also be used to heat the ambient air that is passed through to collect the desiccant's moisture.

In a second embodiment, where commercial electrical power is unavailable, a generator may be used to power the system. When a generator is used, a heat transfer exchange may use heat from fuel burned by the generator to also heat air provided to the desiccant. By making use of the heat generated by the generator, the system operates efficiently and resourcefully. When heat is provided to the air entering the moisture-laden desiccant via the desuperheater from the excess heat created by the refrigeration cycle and the exhaust heat recovery system that uses heat from the generator, the third electrical heater may be used sparingly or not at all.

### BRIEF DESCRIPTION OF THE DRAWINGS

For a better understanding of the present invention, reference may be made to the following accompanying drawings.

FIG. 1 is an exploded view of a water production system constructed according to the teachings hereof.

FIG. 2 is a schematic of an engine heat recovery system of the water production system of FIG. 1.

### DETAILED DESCRIPTION OF THE INVENTION

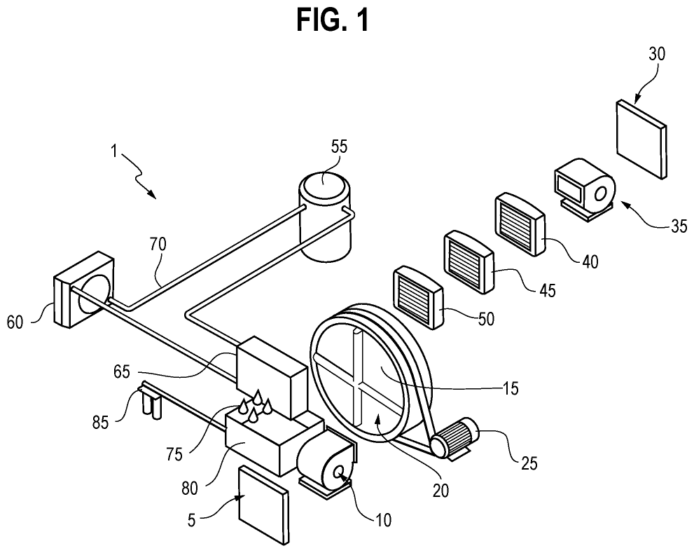

A water production system 1 and various components included in the system 1 are illustrated in FIG. 1. Ultimately, the system 1 takes in ambient air from two locations and subsequently generates potable water.

Initially a first volume of ambient air may be pulled through or blown into a filter media 5, for example by a blower 10. That same air is moved across approximately three-fourths of a surface area 15 of a slowly rotating desiccant wheel 20. Other desiccant structures that contain desiccant (besides the wheel 20) are foreseeable. A motor 25 preferably drives rotation of the wheel 20. The motor 25 (and other mechanisms of the system 20) may be powered by commercial electrical power or by a generator, as described in greater detail herein. As the air moves across the wheel 20, the desiccant absorbs the moisture present in the air. Dry waste air, from which moisture has been absorbed in the desiccant, is vented from the system 1 using known or foreseeable structures and methods in the art.

Regeneration and removal of the moisture absorbed by the desiccant may be accomplished by adding heat to the desiccant. As such, a second volume of ambient air is introduced to the system 1 by a second air filter 30 and a blower 35. The blower 35 may be placed immediately downstream of the air filter 30 so it can blow air into the heaters described below, or it may be located downstream of the filter 30 so that air is drawn through the filter 30 and blown to the heaters.

In the illustrated example, three heaters are provided between the blower 35 and the desiccant wheel 30. A first desuperheater 40 draws heat generated during the refrigeration cycle (described below) and uses the generated heat to increase the temperature of the ambient air entering the system 1 via the filter 30. A second exhaust heat recovery heater 45 is active when the system 1 is being powered by a generator, but not when the system 1 is being powered by commercial electrical power. A third electric heater 50 is also provided that further increases the temperature of the airflow, prior to its introduction to the desiccant wheel 20. The heaters 40, 45, 50 may operate together to heat the air to a suitable temperature.

Output of the electric heater 50 may be modulated based on heat added by one or both of the heaters 40, 45. Specifically, depending on the amount of heat supplied by heaters 40 and 45, electric heater 50 may be modulated to provide an additional amount of heat to raise the temperature of the airflow to a desired temperature (which may be 300 degrees Fahrenheit in some example embodiments). As will be understood, as the engine generator load increases, the exhaust gas temperature increases proportionally. This creates additional heat energy available for input into the regeneration process. Higher exhaust gas temperatures create additional heat available for recovery and subsequently the heated air directed to the desiccant wheel 20 requires less electrically generated heat. The same may be true of heat reused from the refrigeration cycle, discussed below.

After the air is heated by the heaters 40, 45, and/or 50, the hot airflow is moved through approximately one-fourth of the surface area 15 of the rotating desiccant wheel 20, which has now been saturated by air entering the desiccant when via the filter 5 as described above. The heated air may blow through the desiccant wheel 20, and because it is heated, may deactivate the desiccant. The hot airflow thereby absorbs moisture from the desiccant. Such warm, moisture-laden air that has been output from the desiccant regeneration process may then be forced over a refrigeration system bringing that volume of air to saturation and dew point condensing its sustained water vapor in to liquid water.

The refrigeration system generally includes a compressor 55, a condenser 60, and an evaporator 65. As known and understood in the art, the refrigeration system preferably operates as a closed-loop system in communication via a conduit (e.g., pipe) 70. In operation, the compressor 55 first compresses refrigerant vapor and moves it toward the condenser 60 via the conduit 70. The heat of compression raises the temperature of the refrigerant vapor, causing it to be a high pressure superheated vapor. As the refrigerant moves into the condenser 60, the condenser 60 rejects the heat in the refrigerant, causing it to change state and condense into a high pressure, high temperature liquid. As the refrigerant passes through a metering device, its temperature, pressure, and state change once again. Some of the low-pressure liquid refrigerant boils off, forming “flash gas.” As the mixture of liquid and gas pass through the evaporator 65, a super-cooled surface is created. When warm, moisture-laden air is passed over this surface, the humidity in the air condenses into liquid water 75, which may be collected in a reservoir 80. Collected water may be subsequently treated by a filter 85 that may filter for sediment and carbon. Filtration of the collected water may include ultraviolet sterilization processes.

Heat is absorbed and remaining liquid refrigerant changes its state back into a vapor. At the outlet of the evaporator 65, most or all of the low-pressure vapor flows back through the conduit 70 to the compressor 55, causing the water vapor to change to a liquid state, at which time the process may begin again.

Unlike other systems that may generate water, the system 1 makes use of heat generated by the refrigeration system. More particularly, the desuperheater 40 may be in communication with the conduit 70 between the compressor 55 and the condenser 60. As described above, when the compressor 55 compresses the refrigerant, hot, high pressure gas is generated. This also creates what is known as “super heat,” which is heat above saturation point. The condenser 60 rejects the heat in the refrigerant, as it changes state and condenses into a high pressure, high temperature liquid. However, the desuperheater 40 may use that same rejected heat to help heat air introduced to the system 1 via the filter 30. By using this generated heat, the load borne by the electric heater 50 may be reduced. The desuperheater 40 may use the heat generated by the refrigeration system when the system 1 is powered by a commercial electrical system or by a generator.

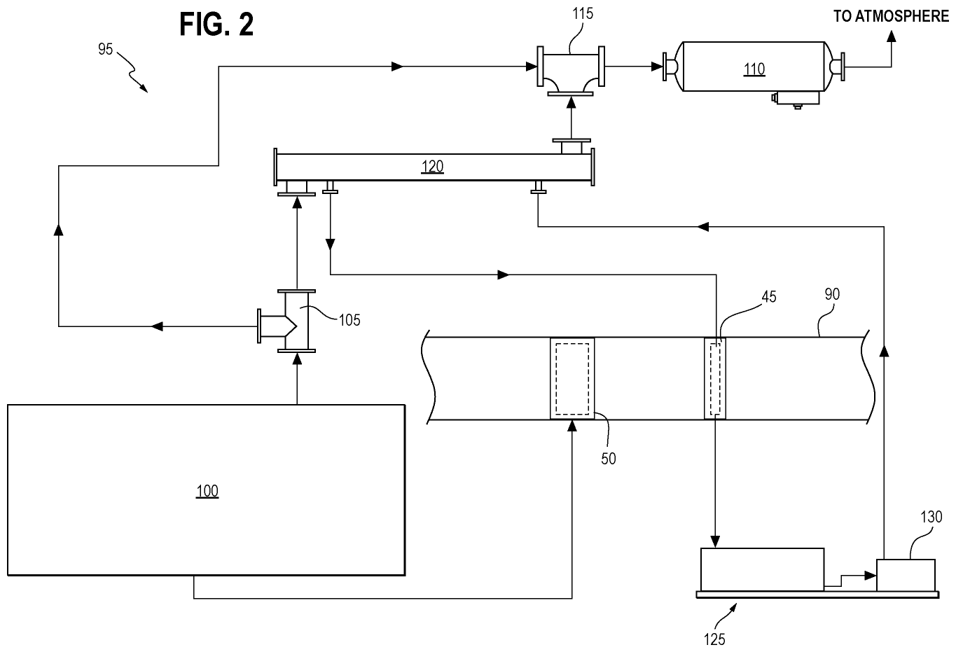

When a generator is used, additional heat may be provided to the air introduced to the system 1 via the exhaust heat recovery heater 45. Turning to FIG. 2, the heater 45 is illustrated in a plenum 90 that may contain the electric heater 50 and the desuperheater 40 (not illustrated). The heater 45 makes up a larger heat recovery system 95 that makes use of excess heat generated by a generator, such as generator 100.

When the generator 100 is running, but the water production process of the system 1 is not in operation, engine generator exhaust is diverted via an exhaust bypass tee 105 to an exhaust silencer 110 via a pipe tee 115, where it is vented to atmosphere. In doing so, the exhaust bypasses the tube heat exchanger described below that supplies heat to the system 1 via the heater 45.

When the generator 100 is running and the water production process of the system 1 is in operation, exhaust is diverted from the exhaust bypass tee 105 to a heat recovery shell and tube heat exchanger 120. The heat exchanger 120 is a “shell and tube”-type heat exchanger. The heat exchanger 120 is an open flow type heat exchanger wherein heat transfer oil is circulated through a series of tubes and exhaust air is forced over the tubes.

Exhaust gas may travel the length of a shell (not illustrated) of the heat exchanger 120 and exit to the exhaust silencer 110 and then to atmosphere. A food grade, non-toxic heat transfer oil (e.g., XCELTHERM 600) is circulated through a tube portion (not illustrated) of the heat exchanger 120 by a hot oil power unit 125.

The hot oil power unit 125 may include an electrically driven mechanical fluid pump 130 and storage tank (not illustrated). The hot oil power unit 125 may circulate heat transfer oil through the exhaust heat exchanger 120 and the air to oil heat exchanger 45 in the system 1. Heat energy from the exhaust may be transferred to the fluid before it is circulated to the air to oil heat exchanger 45 located in system 1. This heat may subsequently be transferred to the air stream prior to the electric heater 50 and may supplement the heat required to regenerate the desiccant wheel 20.

The system 1 may be housed within a cabinet-style container such that it its above-described components may be safely stored therein.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

1. A water production system, the system comprising:
a desiccant assembly comprising a desiccant;
means for driving the rotation of the desiccant;
a first means for introducing ambient air to the desiccant assembly for extraction of moisture vapors from air;
a second means for introducing ambient air to the desiccant assembly for sorption of moisture from the desiccant assembly;
a refrigeration system, the refrigeration system including an evaporator, compressor, and condenser in fluid communication with one another;
a desuperheater in thermal communication with the refrigeration system, the desuperheater being positioned and located such that ambient air drawn into the desiccant assembly for sorption passes through the desuperheater prior to introduction to the desiccant assembly;
an electric heater positioned and located such that ambient air drawn into the desiccant assembly for sorption passes through the electric heater prior to introduction to the desiccant assembly; and
a water collection reservoir for collecting water created when ambient air, heated by the desuperheater and the electric heater, passes through the desiccant assembly for sorption, and then over the evaporator.

2. The system of claim 1, wherein the system is powered by commercial electrical power.

3. The system of claim 1, wherein the system is powered by a generator.

4. The system of claim 3, wherein the system includes an exhaust heat recovery heater positioned and located such that ambient air drawn into the desiccant assembly for sorption will pass through the exhaust heat recovery heater prior to introduction to the desiccant assembly.

5. The system of claim 4, wherein the system includes a heat recovery system, the heat recovery system including the exhaust heat recovery heater.

6. The system of claim 5, wherein the heat recovery system includes a heat exchanger that uses exhaust from the generator to heat oil circulating through the heat exchanger such that the oil may subsequently heat the exhaust heat recovery heater.

7. The system of claim 1, wherein the first means for introducing ambient air to the desiccant assembly is a blower.

8. The system of claim 1, wherein the second means for introducing ambient air to the desiccant assembly is a blower.

9. The system of claim 1, wherein the system includes a filter through which ambient air passes before it is introduced to the desiccant assembly for extraction of moisture vapors from air.

10. The system of claim 1, wherein the system includes a filter through which ambient air passes before it is introduced to the desiccant assembly for sorption of moisture vapors from the desiccant assembly.

11. A water production system, the system comprising:
a generator for powering the system;
a desiccant assembly comprising a desiccant;
means for driving the rotation of the desiccant;
a first means for introducing ambient air to the desiccant assembly for extraction of moisture vapors from air;
a second means for introducing ambient air to the desiccant assembly for sorption of moisture from the desiccant assembly;
a refrigeration system, the refrigeration system including an evaporator, compressor, and condenser in fluid communication with one another;
a desuperheater in thermal communication with the refrigeration system, the desuperheater being positioned and located such that ambient air drawn into the desiccant assembly for sorption passes through the desuperheater prior to introduction to the desiccant assembly;
an electric heater positioned and located such that ambient air drawn into the desiccant assembly for sorption passes through the electric heater prior to introduction to the desiccant assembly;
an exhaust heat recovery heater in thermal communication with the generator, the exhaust heat recovery heater positioned and located such that ambient air drawn into the desiccant assembly for sorption passes through the exhaust heat recovery heater prior to introduction to the desiccant assembly; and
a water collection reservoir for collecting water created when ambient air, heated by the desuperheater and the electric heater, passes through the desiccant assembly for sorption, and then over the evaporator.

12. The system of claim 11, wherein the system includes a heat recovery system, the heat recovery system including the exhaust heat recovery heater.

13. The system of claim 12, wherein the heat recovery system includes a heat exchanger that uses exhaust from the generator to heat oil circulating through the heat exchanger such that the oil may subsequently heat the exhaust heat recovery heater.

14. The system of claim 11, wherein the first means for introducing ambient air to the desiccant assembly is a blower.

15. The system of claim 11, wherein the second means for introducing ambient air to the desiccant assembly is a blower.

16. The system of claim 11, wherein the system includes a filter through which ambient air passes before it is introduced to the desiccant assembly for extraction of moisture vapors from air.

17. The system of claim 11, wherein the system includes a filter through which ambient air passes before it is introduced to the desiccant assembly for sorption of moisture vapors from the desiccant assembly.

18. A method for producing water, the method comprising the steps of:
providing a first ambient air to a desiccant assembly, the desiccant assembly including a desiccant for extraction of moisture vapors from air;
providing a second ambient air to a desuperheater that extracts energy from a refrigeration system to heat the second ambient air;
providing the second ambient air to an electric heater that further heats the second ambient air;
providing the second ambient air to the desiccant assembly for sorption of moisture vapors from the desiccant assembly;
providing the second ambient air to an evaporator of the refrigeration system to generate water; and
collecting the water.

19. The method of claim 18, further comprising the step of using a generator to power at least rotation of the desiccant assembly.

20. The method of claim 19, further comprising the step of heating the second ambient air prior to its introduction to the desiccant assembly via heat generated by exhaust from the generator.
